(19) United States
(12) Patent Application Publication
(10) Pub. No.: US 2013/0151615 A1
(43) Pub. Date: Jun. 13, 2013

(54) SHARING PERSONALLY OWNED MEDIA WITH PEERS VIA SOCIAL GRAPHS

(71) Applicant: Yaoshiang Ho, San Francisco, CA (US)

(72) Inventor: Yaoshiang Ho, San Francisco, CA (US)

(73) Assignee: Google Inc., Mountain View, CA (US)

(21) Appl. No.: 13/584,712

(22) Filed: Aug. 13, 2012

Related U.S. Application Data
(60) Provisional application No. 61/568,616, filed on Dec. 8, 2011.

(51) Int. Cl. G06F 15/16

(52) U.S. Cl. 709/204

(57) ABSTRACT

Configurations for providing a personal media catalog or catalog including different types of media that is owned by a user to enable renting or lending to the user's contact within the user's social graph. The personal media catalog can be provided within a given online social network that can be viewed by the user's contacts. The personal media catalog can be included in the user's profile or in a separate page within the online social network. Additionally, the personal media catalog can be presented in a format facilitates browsing of one or more items in the personal media catalog (e.g., cover flow, gallery, slideshow, etc.). The personal media catalog can one or more different types of media that are available to be rented or lent to the user's contacts, including different types of packaged media (e.g., books, compact discs, digital video discs, magazines, records, tapes, etc.) or electronic/downloadable media.

### CROSS-REFERENCE TO RELATED APPLICATIONS

The present application claims the benefit of priority under 35 U.S.C. §119 from U.S. Provisional Patent Application Ser. No. 61/568,616 entitled “Sharing Personally Owned Media with Peers Via Social Graphs,” filed on Dec. 8, 2011, the disclosure of which is hereby incorporated by reference in its entirety for all purposes.

### BACKGROUND

People use electronic social networking services as tools for building and maintaining networks of personal, familial, academic, professional, and other interpersonal relationships. Collectively, a user's network of relationships is referred to as the user's social graph.

### SUMMARY

In some configurations, the subject technology provides for sharing different media between one or more contacts. The subject technology determines one or more types of media owned by a user. The one or more determined types of media are then shared to one or more contacts in which the one or more contacts are respective users in an online social network. Further, the subject technology offers the shared one or more types of media for renting to the one or more contacts in the online social network.

In some configurations, the subject technology further provides for requesting one or more shared media from a contact. The subject technology selects at least one shared media for renting among one or more shared media from a contact of a user. A request for the at least one selected shared media is transmitted to the contact. The subject technology then receives the at least one selected shared media from the contact for a rental period.

In some configurations, yet another aspect of the subject technology provides a system for sharing different media between one or more contacts. The system includes memory, one or more processors and one or more modules stored in memory and configured for execution by the one or more processors. The system includes a personal media catalog module configured to determine one or more types of media owned by a user. The system further includes a media sharing module configured to share the one or more types of media to one or more contacts. Additionally, the system includes a comments module configured to receive one or more comments for the shared one or more types of media.

In some configurations, the subject technology further provides for determining one or more types of media owned by a user. The one or more types of media are shared to one or more contacts in which the one or more contacts are contacts within the user's social graph in an online social network. The shared one or more types of media are offered for renting to the one or more contacts. The subject technology then receives a selection for at least one of the shared one or more types of media for renting.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The features of the subject technology are set forth in the appended claims. However, for purpose of explanation, several configurations of the subject technology are set forth in the following figures.

FIG. 1 conceptually illustrates an example process for sharing different media between one or more contacts of a user's social graph in an online social network.

FIG. 2 conceptually illustrates an example process for requesting one or more shared media from a contact of a user's social graph in an online social network.

FIG. 3 conceptually illustrates a graphical user interface (GUI) in which some configurations of the subject technology can be implemented.

FIG. 4 conceptually illustrates an example computing environment.

FIG. 5 conceptually illustrates an example application programming interface (API) architecture.

FIG. 6 conceptually illustrates a system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details. In some instances, structures and components are shown in block diagram form in order to avoid obscuring the concepts of the subject technology.

An online service can provide rental of DVD and Blu-Ray discs and/or provide streaming of media content. However, an online rental service however can require that the user sign up for the service and/or charge higher prices to consumers than actual costs under a subscription model. Other web sites that provide new packaged media or secondary markets (e.g., used packaged media) can offer purchase transactions but do not provide a rental model for different types of media. Moreover, the aforementioned services or sites do not easily enable the user to share purchased and/or rented items to the user's contacts and/or friends so as to encourage interaction between the user's contacts.

A consumer that purchases or rents different types of media can associate their personal identity through purchases of the media. For example, the consumer can wish to let their peers or friends know that they have purchased the latest movie from a certain director, a novel from a particular author and/or a new album from a music artist. For instance, the user can opt-in to sharing their purchases of different types of media from different services, content sources, or vendors. In a given online social network, a user can edit their profile to include interests such as movies, books, music, etc. As used herein, a user's profile encompasses its plain and ordinary meaning, and may refer to an online representation of the user that includes profile information for associating one or more types of data to the user. For example, the user can provide information related to their interests in different types of categories (e.g., movies, books, magazines, music etc.), contact information, education, or additional demographic information. However, the user's profile information in the social networking service is not typically associated with various forms of media that can be rented or lent out to other contacts within the user's social graph. In a given online social network, the user's profile is presented with the user's profile information in a flat list view in which profile information is listed vertically in a predetermined order. Moreover, this type of presentation does not facilitate browsing in a more engaging manner (e.g., as provided in a gallery view) and does not promote interaction between the user and his or her contacts within the social graph (e.g., by allowing comments).

An online social network encompasses its plain and ordinary meaning, and may refer to a service that provides an online community of individuals or contacts that share common background, attributes, interests and/or activities, and who are interested in meeting and/or interacting with other individuals in the online social network. In one example, the online social network is web based and provides different ways for users to interact (e.g., e-mail, instant messaging, posting status updates, check-ins into a location(s), and posting comments on each other's social network profile pages, etc.). As used herein, the expression “social graph” encompasses its plain and ordinary meaning, including, but not limited to, a collection of relationships between the user and one or more contacts in the online social network. In particular, a user's social graph refers to the user's network of relationships based on one or more contacts.

To address the aforementioned issues, the subject technology provides a personal media catalog or library, including different types of media that is owned by a user to enable renting or lending to the user's contact within the social graph. As used herein, the expression “personal media catalog” encompasses its plain and ordinary meaning, including, but not limited to, a collection of one or more types of media owned by a user that may be provided for display and/or receive input or requests from other users for performing one or more actions on the personal media catalog. In one example, the types of media include physical formats such as a compact disc, book, audio tape, video tape, etc. Other types of media can be included and still be within the scope of the subject technology.

In some implementations, the personal media catalog can be provided within a given online social network that can be viewed by the user's contacts within the user's social graph. For instance, the personal media catalog can be included in the user's profile or in a separate page within the online social network. In another example, the personal media catalog may be provided as an application within the online social network that may be accessed by one or more users and/or contacts.

The personal media catalog can be presented in a format that facilitates browsing of one or more items in the personal media catalog (e.g., cover flow, gallery, slideshow, etc.). The personal media catalog can be one or more different types of media that are available to be rented or lent to the user's contacts. For instance, the different media in the personal media catalog can include different types of packaged media (e.g., books, compact discs (CDs), digital video discs (DVDs), magazines, records and tapes) or electronic/downloadable media. A contact therefore can submit a request for an item from the user's personal media catalog. Moreover, the contact can provide comments for items within the personal media catalog.

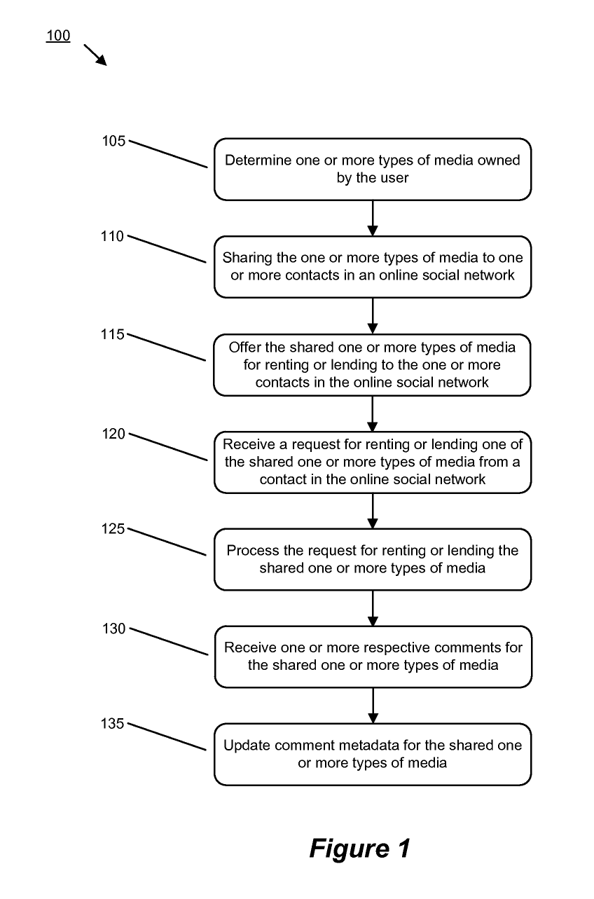

FIG. 1 conceptually illustrates an example process 100 sharing different media between one or more contacts of a user's social graph in an online social network. The process 100 is performed by one or more computing devices or systems in some configurations. For instance, an online social networking system can perform the operations in the process 100 described in further detail below to provide a personal media catalog for the user.

The process 100 begins at 105 by determining one or more types of media owned by the user for inclusion in the user's personal media catalog. The types of media can be one or more types of physical media such as books, compact discs (CDs), digital video discs (DVDs), magazines, records and tapes or different electronic/downloadable media (e.g., electronic books, digital music, digital movies, etc.). Thus, the personal media catalog can include one or more items corresponding to one or more types of media. As used herein, the term “item” refers to a respective product of a respective type of media provided in the personal media catalog.

Different ways of populating the personal media catalog of the user can be provided. In some configurations, the process 100 determines the types of media owned by the user by identifying one or more items of each determined type of media based on the user's profile data for an online social network. In another example, the process 100 can aggregate information related to the user's personal media catalog from different services. The user may own different media from different services or vendors that provide different types of media (e.g., books, music, movies, etc.). The user can opt-in to sharing purchased media from respective services or vendors that enables the process 100 to aggregate the user's purchase information. Moreover, the user can manually add one or more items to the personal media catalog.

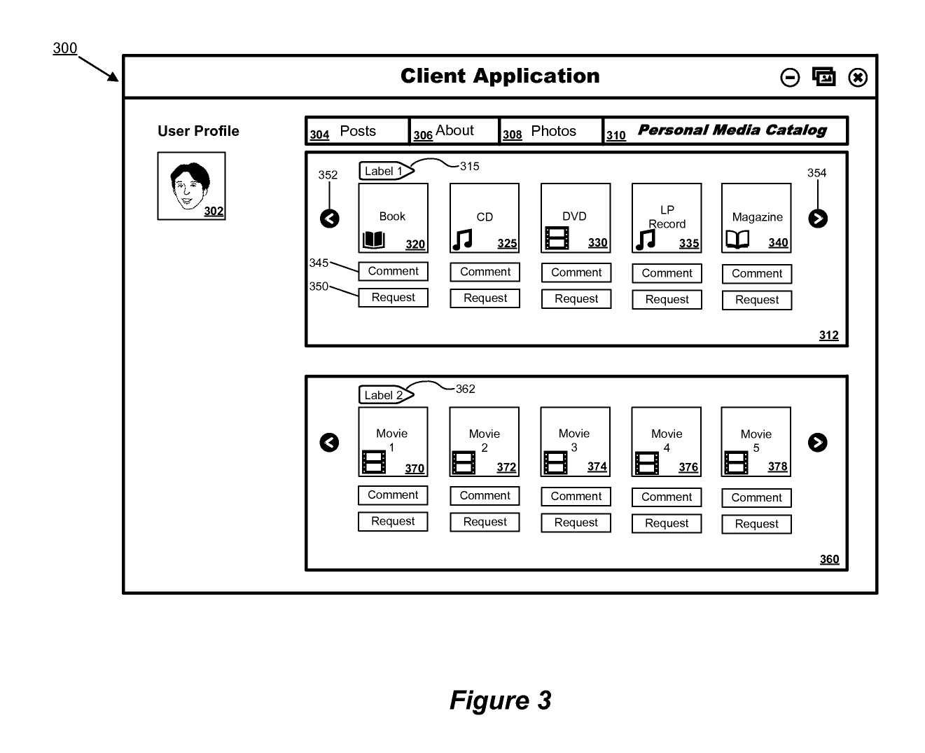

At 110, the process 100 shares the determined one or more types of media to one or more contacts. The one or more contacts are social networking contacts of the user in an online social network in some configurations. In one example, the process 100 shares the determined one or more types of media by providing for display the determined one or more types of media. The process 100, for instance, provides the shared types of media in a gallery view that enables browsing of the media in a user-friendly manner. An example graphical user interface (GUI) for displaying the shared types of media is described in further detail in FIG. 3.

The process at 115 offers the shared one or more types of media for renting or lending to the one or more contacts in the social network. In one example, the process 100 offers the shared one or more types of media by enabling a request to be transmitted from one or more contacts for renting or lending the shared media types. The user can select one or more items in the personal media catalog for renting or lending in some configurations. For instance, the user may only wish to provide a subset of items in the personal media catalog for renting or lending. In this manner, the user can control which items are permitted to be rented or lent out to a contact(s) from the user's social graph. Renting an item as used herein encompasses its plain and ordinary meaning, and may refer to providing for the temporary use of the item in exchange for a financial payment. Lending an item as used herein encompasses its plain and ordinary meaning, and may refer to loaning the item for temporary use without a financial payment.

The process at 120 receives a request for renting or lending one of the shared one or more types of media from a contact in the social network. In one example, the request can be received as a message or e-mail in the user's account in the online social network. In some configurations, the user can be alerted when the request is received in order to notify the user that a contact in the user's social graph is requesting one or more items among the shared types of media for renting or lending. The process at 125 then processes the request for renting or loaning the shared one or ore types of media.

In some configurations, the process 100 at 130 receives one or more respective comments for the shared one or more types of media. As used herein, the term “comment” encompasses its plain and ordinary meaning, and may refer to a message from a contact or the user that is associated with a respective item in the personal media catalog. By way of example, a contact from the user's social graph may wish to borrow an item in the user's personal media catalog that the user has not selected for renting or lending. The contact sends a comment to the user requesting that the user provide the item for renting or lending. The process 100 can receive any type of comment and still be within the scope of the subject technology. By way of example, the personal media catalog of the user can be an expression of the user's identity. Thus, one or more contacts may submit comments for items in the personal media catalog that facilitates discussion and/or other social interactions based on the user's personal media catalog.

The process 100 at 135 updates content metadata for the shared one or more types of media based on the received respective comments. In some configurations, each item in the personal media library includes comment metadata which tracks one or more messages from one or more contacts and/or the user related to the item. The process 100 updates the content metadata corresponding to respective items in the personal media catalog based on the received respective comments. The process 100 then ends.

Although the process 100 in FIG. 1 illustrates the request for renting or loaning a shared media type occurs at 120 and one or more respective comments are received at 130, the aforementioned operations in the process 100 could occur in a different sequence. In some configurations, not all operations in the process 100 are required in order to be within the scope of the subject technology. For instance, the process 100 could forgo performing the operations at 130 and 135 and/or the operations at 120 and 125.

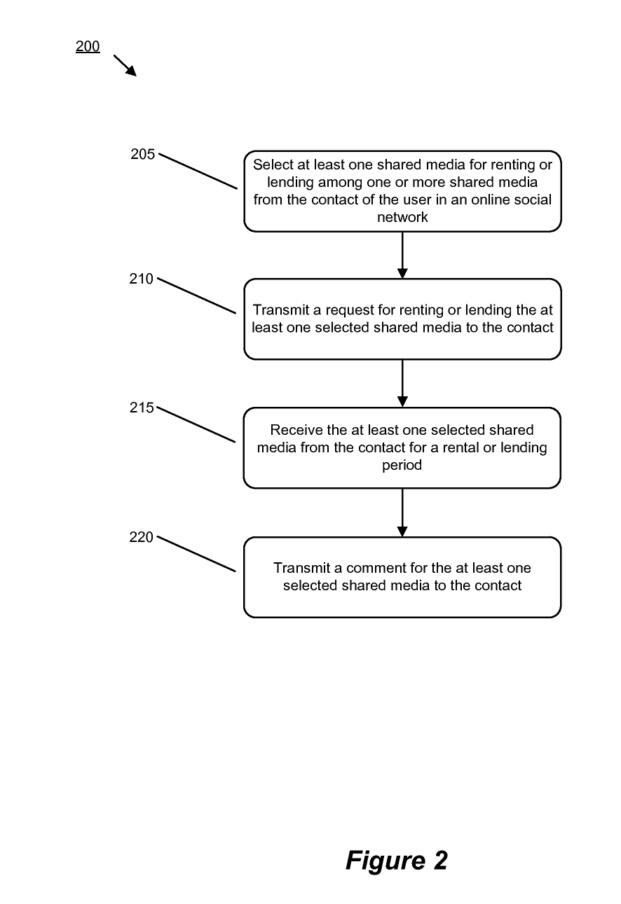

FIG. 2 conceptually illustrates an example process 200 for requesting one or more shared media from a contact in a user's social graph in the social network. The process 200 is implemented by one or more computing devices or systems in some configurations. For instance, a user can browse the contact's personal media library in a given online social network to select one or more items for renting or lending.

The process 200 begins at 205 by selecting at least one shared media for renting among one or more shared media from a contact of the user. In some configurations, the contact is an online social networking contact that has offered one or more different media types for renting or lending in a given online social network. The different media types includes different types of physical media and/or electronic/downloadable media in some configurations.

In one example, the user can view the contact's personal media catalog in order to determine the types of shared media offered by the contact (e.g., as described above in FIG. 1). The shared media includes used shared media that the contact has offered for renting or lending. For instance, used shared media includes one or more items that are considered used merchandise because the items have been previously purchased by the contact for sharing via the online social network. In one example, the used shared media includes different types of physical media purchased by the contact.

The process 200 at 210 transmits a request for renting or lending (i.e., requesting the contact to lend) the at least one selected shared media to the contact. The request in some examples can be received in the contact's message inbox in the online social network and/or transmitted as an alert, notification and/or e-mail to the contact. At 215, the process 200 receives the at least one selected shared media from the contact for a rental or lending period. The rental or lending period can be set by the contact and/or based on a predetermined time period (e.g., a day, a week, a month, etc.).

Further, in some configurations, the process 200 transmits a comment at 220 for the at least one selected shared media to the contact. As described above in FIG. 1, one or more comments may be accepted for each item in the personal media catalog. The process 200 then ends.

Although the process 200 in FIG. 2 illustrates transmitting the request for renting or lending the selected shared media occurs at 210 and transmitting the comment occurs at 220, the aforementioned operations in the process 200 could occur in a different sequence. In some configurations, not all operations in the process 200 are required in order to be within the scope of the subject technology. For instance, the process 200 could forgo performing the operation at 210 or the operation at 220.

FIG. 3 conceptually illustrates a graphical user interface (GUI) 300 in which some configurations of the subject technology can be implemented. More specifically, the GUI 300 can include different sets of graphical elements for displaying a personal media catalog of a user in an online social network as described by reference to the respective processes described in FIGS. 1 and 2. A graphical element can include, but is not limited to, a button, check box, radio button, slider, list box, drop-down list, menu, combo box, icon, text box, scroll bar, etc. In one example, the GUI 300 is displayed in a web client (e.g., a web browser) while accessing the online social network. The GUI 300 in one example represents the user's profile page in the online social network. The profile page includes different information regarding the user and serves as a representation of the user in the online social network. One or more contacts within the user's social graph can view the profile page of the user in order to view the user's personal media catalog (e.g., as described above in FIGS. 1 and 2).

As illustrated in FIG. 3, the GUI 300 includes a profile photo or image 302 that represents a user in the online social network. The GUI 300 includes tabs 304, 306, 308 and 310 for displaying different pages of the user's profile. FIG. 3 shows that the tab 310 corresponding to the user's personal media catalog is selected (as indicated in bold) for display in the GUI 300.

As further shown in the GUI 300, display areas 312 and 360 are included to show different portions of the user's personal media catalog. The display area 312 includes a label 315 for organizing one or more items in the personal media catalog. In the example GUI 300 of FIG. 3, one or more items are organized under the label 315 in the display area 312. The label 315 in one example can be “Items that I own” to indicate the items that the user has purchased and shared in the personal media catalog. For instance, item 320 corresponds to a book, item 325 corresponds to a CD, item 330 corresponds to a DVD, item 335 corresponds to an long-playing record (e.g., vinyl record), and item 340 corresponds to a magazine.

Each item in the personal media catalog corresponds to a type of media that is shared on the user's profile page. The items are arranged in a gallery view of different graphical representations (e.g., icon, image, etc.) corresponding to the items. The gallery view includes a respective graphical representation for each of the one or more types of media in some configurations. For example, the respective graphical representations include a thumbnail image corresponding to each item in the personal media catalog.

The user can utilize navigational arrows 352 and 354 for scrolling through additional items in the gallery view. Further, each item can include graphical elements such as buttons 345 and 350 for respectively commenting on an item and requesting the item for renting or lending.

As further shown in the GUI 300, the display area 360 includes a label 362 for organizing one or more items in the user's personal media library. The label 362 can organize items 370, 372, 374, 376 and 378 in the display area 360. Further, as discussed above, each of the items can also have corresponding comment and request buttons for providing comment(s) and/or requesting an item for renting or lending.

Although the example GUI 300 in FIG. 3 includes two different display areas 312 and 360 for displaying different portions or sections of the personal media library (e.g., according to a corresponding label), any number of sections of the personal media library can be included in the GUI 300 and still be within the scope of the subject technology. Moreover, the items in the personal media catalog can be arranged in the GUI 300 in different ways (e.g., based on one or more different criteria). For example, the GUI 300 can provide different ways to rank and sort the items in the personal media catalog.

Additionally, although the above description of FIG. 3 includes different example graphical elements in the GUI 300, some implementations can include other graphical elements in the GUI 300 and still be within the scope of the subject technology. Further, the GUI 300 is not required to include all of the aforementioned graphical elements.

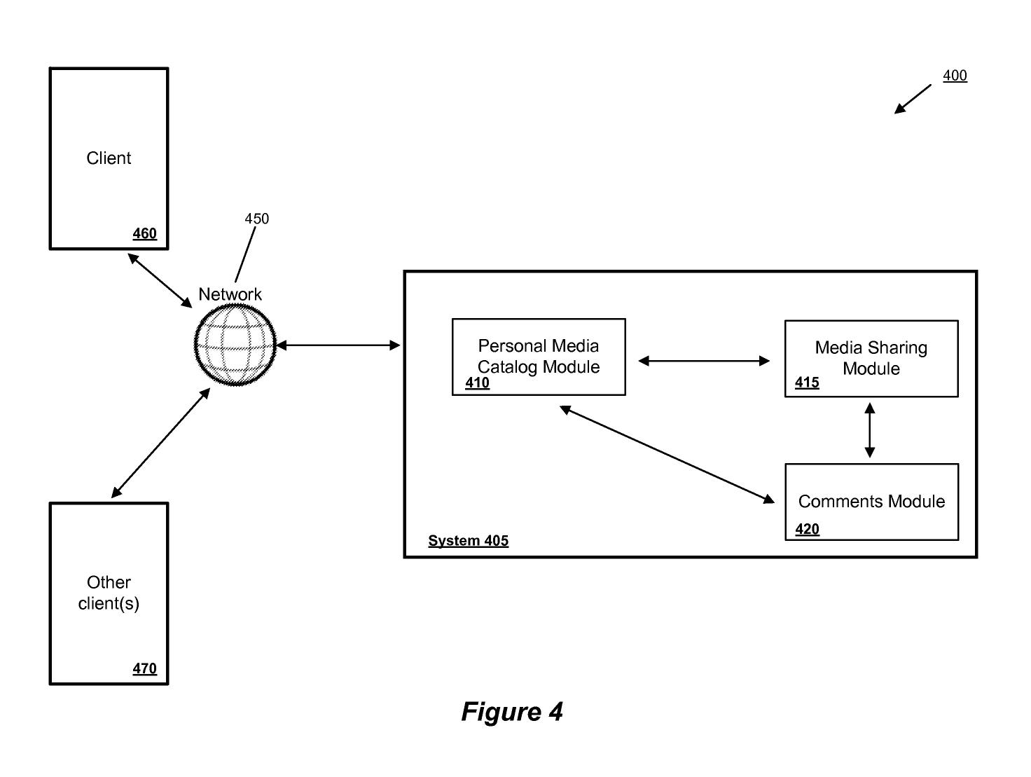

FIG. 4 conceptually illustrates an example computing environment 400 including a system. In particular, FIG. 4 shows a system 405 for implementing the above described processes in FIGS. 1 and 2 and the GUI in FIG. 3. In some configurations, the system 405 is part of an implementation running a particular machine (e.g., a server).

The system 405 can include memory, one or more processors, and one or more modules stored in memory and configured for execution by the one or more processors. As shown in FIG. 4, the system 405 includes several modules for providing different functionality. The system 405 is configured to include a personal media catalog module 410, a media sharing module 415, and a comments module 420. The personal media catalog 410 is configured to determine one or more types of media owned by the user. The media sharing module 415 is configured to share the one or more types of media to one or more contacts. The media sharing module 415 is further configured to receive one or more requests for renting at least one of the shared one or more types of media. In some configurations, the media sharing module 415 shares the one or more types of media by providing for display the one or more types of media on a profile page of the user. The profile page in one example is similar to the example GUI illustrated in FIG. 3. The comments module 420 is configured to receive one or more comments for the shared one or more types of media.

As further shown in FIG. 4, each of the aforementioned modules can be configured to communicate between each other. For instance, different data, messages, API calls and returns can be passed between the different modules in the system 405.

The system 405 can communicate over a network 450 with a client 460. The client 460 can each be configured to communicate with the aforementioned modules of the system 405. The system 405 can then transmit for display a user's personal media catalog including one or more shared media types over the network 450 to the client 460. The client 460 can transmit a request for renting or lending or commenting on one or more shared media types over the network 450 to the system 405. As further shown in FIG. 4, other client(s) 470 can communicate over the network 450 with the system 405 in a similar manner.

Many of the above-described features and applications are implemented as software processes that are specified as a set of instructions recorded on a machine readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of machine readable media include, but are not limited to, CD-ROMs, flash drives, RAM chips, hard drives, EPROMs, etc. The machine readable media does not include carrier waves and electronic signals passing wirelessly or over wired connections.

In this specification, the term “software” is meant to include firmware residing in read-only memory and/or applications stored in magnetic storage, which can be read into memory for processing by a processor. Also, in some implementations, multiple software components can be implemented as sub-parts of a larger program while remaining distinct software components. In some implementations, multiple software subject components can also be implemented as separate programs. Finally, any combination of separate programs that together implement a software component(s) described here is within the scope of the subject technology. In some implementations, the software programs, when installed to operate on one or more systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some configurations are implemented as software processes that include one or more application programming interfaces (APIs) in an environment with calling program code interacting with other program code being called through the one or more interfaces. Various function calls, messages or other types of invocations, which can include various kinds of parameters, can be transferred via the APIs between the calling program and the code being called. In addition, an API can provide the calling program code the ability to use data types or classes defined in the API and implemented in the called program code.

One or more APIs may be used in some configurations. An API is an interface implemented by a program code component or hardware component (“API implementing component”) that allows a different program code component or hardware component (“API calling component”) to access and use one or more functions, methods, procedures, data structures, classes, and/or other services provided by the API implementing component. An API can define one or more parameters that are passed between the API calling component and the API implementing component.

An API allows a developer of an API calling component (that could be a third party developer) to utilize specified features provided by an API implementing component. There may be one API calling component or there may be more than one such component. An API can be a source code interface that a computing system or program library provides to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some configurations the API implementing component may provide more than one API, each providing a different view of or with different aspects that access different aspects of the functionality implemented by the API implementing component. For example, one API of an API implementing component can provide a first set of functions and can be exposed to third party developers, and another API of the API implementing component can be hidden (not exposed) and provide a subset of the first set of functions and also provide another set of functions, such as testing or debugging functions which are not in the first set of functions. In other configurations the API implementing component may itself call one or more other components via an underlying API and thus be both an API calling component and an API implementing component.

An API defines the language and parameters that API calling components use when accessing and using specified features of the API implementing component. For example, an API calling component accesses the specified features of the API implementing component through one or more API calls or invocations (embodied for example by function or method calls) exposed by the API and passes data and control information using parameters via the API calls or invocations. The API implementing component may return a value through the API in response to an API call from an API calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API calling component) and an API implementing component. Transferring the API calls may include issuing, initiating, invoking, calling, receiving, returning, or responding to the function calls or messages. In other words, transferring can describe actions by either of the API calling component or the API implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API implementing component. The API calling component therefore can declare variables, use pointers to, use or instantiate constant values of such types or classes by using definitions provided in the API.

Generally, an API can be used to access a service or data provided by the API implementing component or to initiate performance of an operation or computation provided by the API implementing component. By way of example, the API implementing component and the API calling component may each be any one of an operating system, a library, a device driver, an API, an application program, or other module (it should be understood that the API implementing component and the API calling component may be the same or different type of module from each other). API implementing components may in some cases be embodied at least in part in firmware, microcode, or other hardware logic. In some configurations, an API may allow a client program to use the services provided by a Software Development Kit (SDK) library. In other configurations an application or other client program may use an API provided by an Application Framework. In these configurations the application or client program may incorporate calls to functions or methods provided by the SDK and provided by the API or use data types or objects defined in the SDK and provided by the API. An Application Framework may in these configurations provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API calling component may be a local component (i.e., on the same data processing system as the API implementing component) or a remote component (i.e., on a different data processing system from the API-implementing component) that communicates with the API-implementing component through the API over a network. It should be understood that an API implementing component may also act as an API calling component (i.e., it may make API calls to an API exposed by a different API implementing component) and an API calling component may also act as an API implementing component by implementing an API that is exposed to a different API calling component.

The API can allow multiple API calling components written in different programming languages to communicate with the API implementing component (thus the API may include features for translating calls and returns between the API implementing component and the API calling component). The API however can be implemented in terms of a specific programming language. An API calling component can, in one configuration, call APIs from different providers such as a set of APIs from an OS provider and another set of APIs from a plug-in provider and another set of APIs from another provider (e.g. the provider of a software library) or creator of the another set of APIs.

The following description describes an example API architecture in which some configurations of the subject technology can be implemented.

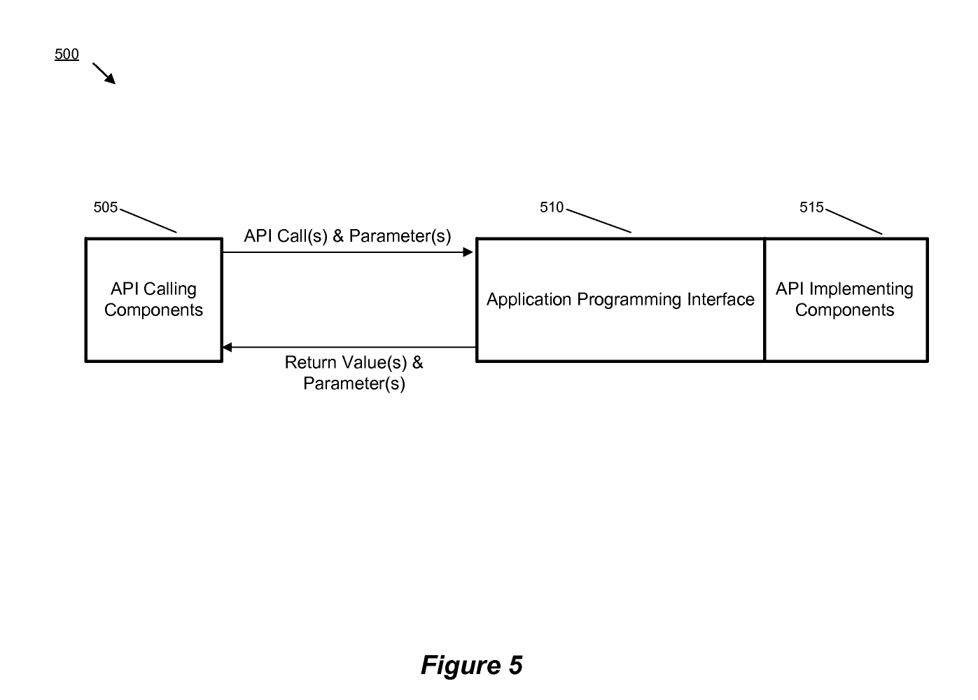

FIG. 5 is a block diagram illustrating an example API architecture, which can be used in some configurations of the subject technology. As shown in FIG. 5, the API architecture 500 includes the API implementing component 515 (e.g., an operating system, a library, a device driver, an API, an application program, software or other module) that implements the API 510. The API 510 specifies one or more functions, methods, classes, objects, protocols, data structures, formats and/or other features of the API-implementing component that can be used by the API-calling component 505. The API 510 can specify at least one calling convention that specifies how a function in the API implementing component receives parameters from the API calling component and how the function returns a result to the API calling component. The API calling component 505 (e.g., an operating system, a library, a device driver, an API, an application program, software or other module), makes API calls through the API 510 to access and use the features of the API implementing component 515 that are specified by the API 510. The API implementing component 515 can return a value through the API 510 to the API calling component 505 in response to an API call.

It will be appreciated that the API implementing component 515 can include additional functions, methods, classes, data structures, and/or other features that are not specified through the API 510 and are not available to the API calling component 505. It should be understood that the API calling component 505 can be on the same system as the API implementing component 515 or can be located remotely and accesses the API implementing component 515 using the API 510 over a network. While FIG. 5 illustrates a single API calling component 505 interacting with the API 510, it should be understood that other API calling components, which can be written in different languages (or the same language) than the API calling component 505, can use the API 510.

The API implementing component 515, the API 510, and the API calling component 505 can be stored in a machine-readable medium, which includes any mechanism for storing information in a form readable by a machine (e.g., a computer or other data processing system). For example, a machine-readable medium includes magnetic disks, optical disks, random access memory, read only memory, flash memory devices, etc.

The following description describes an example system in which aspects of the subject technology can be implemented.

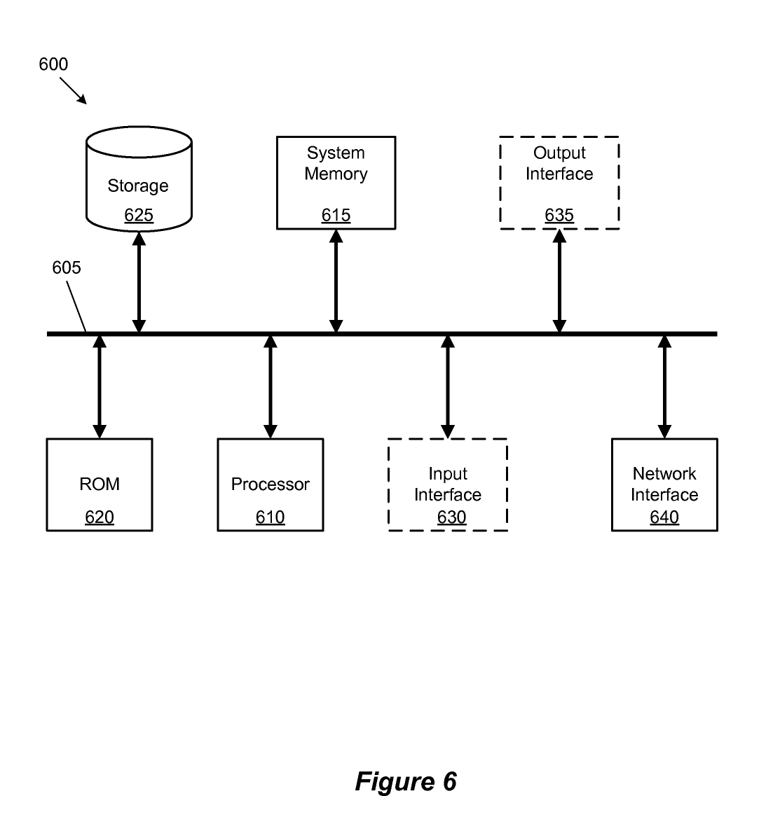

FIG. 6 conceptually illustrates a system 600 with which some implementations of the subject technology can be implemented. The system 600 can be a computer, phone, PDA, or any other sort of electronic device. In some configurations, the system 600 includes a television with one or more embedded processors therein. Such a system includes various types of computer readable media and interfaces for various other types of computer readable media. The system 600 includes a bus 605, processing unit(s) 610, a system memory 615, a read-only memory 620, a storage device 625, an optional input interface 630, an optional output interface 635, and a network interface 640.

The bus 605 collectively represents all system, peripheral, and chipset buses that communicatively connect the numerous internal devices of the system 600. For instance, the bus 605 communicatively connects the processing unit(s) 610 with the read-only memory 620, the system memory 615, and the storage device 625.

From these various memory units, the processing unit(s) 610 retrieves instructions to execute and data to process in order to execute the processes of the subject technology. The processing unit(s) can be a single processor or a multi-core processor in different implementations.

The read-only-memory (ROM) 620 stores static data and instructions that are needed by the processing unit(s) 610 and other modules of the system 600. The storage device 625, on the other hand, is a read-and-write memory device. This device is a non-volatile memory unit that stores instructions and data even when the system 600 is off. Some implementations of the subject technology use a mass-storage device (such as a magnetic or optical disk and its corresponding disk drive) as the storage device 625.

Other implementations use a removable storage device (such as a flash drive, a floppy disk, and its corresponding disk drive) as the storage device 625. Like the storage device 625, the system memory 615 is a read-and-write memory device. However, unlike storage device 625, the system memory 615 is a volatile read-and-write memory, such a random access memory. The system memory 615 stores some of the instructions and data that the processor needs at runtime. In some implementations, the subject technology's processes are stored in the system memory 615, the storage device 625, and/or the read-only memory 620. For example, the various memory units include instructions for processing multimedia items in accordance with some implementations. From these various memory units, the processing unit(s) 610 retrieves instructions to execute and data to process in order to execute the processes of some implementations.

The bus 605 also connects to the optional input and output interfaces 630 and 635. The optional input interface 630 enables the user to communicate information and select commands to the system. The optional input interface 630 can interface with alphanumeric keyboards and pointing devices (also called “cursor control devices”). The optional output interface 635 can provide display images generated by the system 600. The optional output interface 635 can interface with printers and display devices, such as cathode ray tubes (CRT) or liquid crystal displays (LCD). Some implementations can interface with devices such as a touchscreen that functions as both input and output devices.

Finally, as shown in FIG. 6, bus 605 also couples system 600 to a network interface 640 through a network adapter (not shown). In this manner, the computer can be a part of a network of computers (such as a local area network (“LAN”), a wide area network (“WAN”), or an Intranet, or an interconnected network of networks, such as the Internet. Any or all components of system 600 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Configurations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some configurations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components in the configurations described above should not be understood as requiring such separation in all configurations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein can be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect can apply to all configurations, or one or more configurations. A phrase such as an aspect can refer to one or more aspects and vice versa. A phrase such as a “configuration” does not imply that such configuration is essential to the subject technology or that such configuration applies to all configurations of the subject technology. A disclosure relating to a configuration can apply to all configurations, or one or more configurations. A phrase such as a configuration can refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure are expressly incorporated herein by reference and are intended to be encompassed by the claims.

What is claimed is:

1. A machine-implemented method for sharing media, the method comprising:
determining, by one or more computing devices, one or more types of media owned by a user;
sharing, by the one or more computing devices, the one or more determined types of media to one or more contacts, wherein the one or more contacts are respective users in an online social network; and
offering, by the one or more computing devices, the shared one or more types of media for renting to the one or more contacts in the online social network.

2. The method of claim 1, further comprising:
receiving, by the one or more computing devices, a request for renting one of the shared one or more types of media from a contact.

3. The method of claim 1, wherein the one or more types of media includes electronic or downloadable media.

4. The method of claim 1, wherein the one or more types of media includes one or more types of packaged media.

5. The method of claim 4, wherein the one or more types of packaged media includes at least one of books, compact discs (CDs), digital video discs (DVDs), magazines, records and tapes.

6. The method of claim 1, further comprising:
providing, by the one or more computing devices, for display the shared one or more types of media.

7. The method of claim 1, wherein providing for display the one or more types of media comprises a gallery view.

8. The method of claim 7, wherein the gallery view includes a respective graphical representation for each of the one or more types of media.

9. The method of claim 8, wherein the respective graphical representations comprises a thumbnail image.

10. The method of claim 6, wherein providing for display the one or more types of media is separate from a display of the user's profile in the online social network.

11. The method of claim 1, further comprising;
offering, by the one or more computing devices, the shared one or more types of media for lending to the one or more contacts.

12. The method of claim 1, wherein the one or more contacts are online social networking contacts of the user.

13. The method of claim 1, further comprising:
receiving, by the one or more computing devices, one or more respective comments for the shared one or more types of media.

14. A machine-implemented method for requesting one or more shared media from a contact, the method comprising:
selecting, by one or more computing devices, at least one shared media for renting among one or more shared media from a contact of a user, wherein the contact is a respective user in an online social network;
transmitting, by the one or more computing devices, a request for renting the at least one selected shared media to the contact; and
receiving, by the one or more computing devices, the at least one selected shared media from the contact for a rental period.

15. The method of claim 14, wherein the shared media comprises used shared media of the contact.

16. The method of claim 15, wherein the used shared media comprises used merchandise.

17. The method of claim 16, wherein the used merchandise was previously purchased by the contact.

18. The method of claim 14, further comprising:
transmitting, by the one or more computing devices, a request for lending the at least one selected shared media to the contact.

19. A non-transitory system for sharing different media between one or more contacts, the system comprising:
memory;
one or more processors;
one or more modules stored in memory and configured for execution by the one or more processors, the modules comprising:
a personal media catalog module configured to determine one or more types of media owned by a user;
a media sharing module configured to share the one or more types of media to one or more contacts, wherein the one or more contacts are respective users in an online social network; and
a comments module configured to receive one or more comments for the shared one or more types of media.

20. The system of claim 19, wherein the media sharing module is further configured to receive one or more requests for renting at least one of the shared one or more types of media.

21. The system of claim 19, wherein the media sharing module shares the one or more types of media by providing for display the one or more types of media on a profile page of the user.

22. A non-transitory machine-readable medium comprising instructions stored therein, which when executed by a machine, cause the machine to perform operations comprising:
determining, by the one or more computing devices, one or more types of media owned by the user;
sharing, by the one or more computing devices, the one or more types of media to one or more contacts, wherein the one or more contacts are contacts within the user's social graph in an online social network;
offering, by the one or more computing devices, the shared one or more types of media for renting to the one or more contacts; and
receiving, by the one or more computing devices, a selection for at least one of the shared one or more types of media for renting.
